(19) United States
(12) Patent Application Publication
(10) Pub. No.: US 2010/0006612 A1
(43) Pub. Date: Jan. 14, 2010

(54) FASTENING DEVICE FOR A VEHICLE LOAD CARRIER

(75) Inventor: HANS ODIN, Värnamo (SE)

Correspondence Address: NOVAK DRUCE AND QUIGG, LLP (Thule), 1000 LOUISIANA STREET, FIFTY-THIRD FLOOR, HOUSTON, TX, 77002, US

(73) Assignee: Thule Sweden AB, Hillerstorp (SE)

(21) Appl. No.: 12/487,382

(22) Filed: Jun. 18, 2009

Related U.S. Application Data
(63) Continuation-in-part of application No. PCT/SE2007/001105, filed on Dec. 13, 2007.

(30) Foreign Application Priority Data
Dec. 18, 2006 (SE) 0602740-3

(51) Int. Cl. B60R 9/058; B60R 9/052

(52) U.S. Cl. 224/329; 224/555

(57) ABSTRACT

Fastening method and device for detachably fixing a load carrier to a vehicle that includes a bracket configured to be affixed to a roof of the vehicle. The bracket has at least one elongate recess or hole for detachably clamping a load carrier foot. The load carrier foot includes an axially movable hooked member or bolt with a hooked portion having an elongated shape, which is configured to be moved through the elongated recess. The hooked member is twistable in the recess to axially lock the hooked member against the bracket. The elongate recess or hole may have longitudinally elongate or arched longitudinal edges, and corresponding ledge surfaces, whereby the hooked portion of the hooked member, for example a head of the bolt, may longitudinally slide along the longitudinally elongate or arched ledge surfaces and tilt forward in the event of a sudden slowing or stopping of the vehicle, for instance, in a crash. The sliding motion is facilitated by an engagement surface of the hooked portion that is width-wise more narrow than the ledge surface is long.

### RELATED APPLICATION(S)

The present application is a continuation-in-part application of PCT Application PCT/SE2007/001105 filed Dec. 13, 2007 which claims priority to Application SE0602740-3 filed Dec. 18, 2006. Said applications are hereby expressly incorporated by reference into the present application in their entireties.

### FIELD

The present disclosure relates to devices for fastening a load carrier to a vehicle.

### BACKGROUND

Previously known fastening devices for railings are shown by example in GB 2 386 591 and JP2005297841. These fastening devices comprise (include) a bracket, which is firmly fastened to a carrying vehicle and to the railing. A problem with such known fastening devices is that they can loosen on the vehicle during sudden slowing or stopping of the vehicle, for instance in a collision, or the roof of the vehicle can deform resulting in unnecessary cost and risk to the vehicle owner even in only a minor accident.

### BRIEF DESCRIPTION OF THE FIGURES

A load carrier foot according to the present disclosure is described hereafter with reference to the accompanying figures which serve as a part of said disclosure and in which:

FIG. 1 is an illustrative schematic perspective view of a load carrier foot 1 with a fastening device configured according to the present invention and shown in an installed configuration;

FIG. 2 is an illustrative schematic side elevational view of a fastening device that includes an anchoring bracket 3 and a hooked member 6 for clamp-securing a load carrier foot to a carrying vehicle, said fastening device being shown in a first, preinstalled mounting position in which a hooked portion 7 of the hooked member is inserted down into a receiving recess or aperture 5 of the bracket, but not yet twisted into engagement therewith;

FIG. 3 is an illustrative schematic side elevational view of the fastening device of FIG. 2, but with the hooked portion twisted into position and abutingly fastened on the recess in the installed configuration;

FIG. 4A is an illustrative schematic perspective view showing the bracket of the fastening device upside down;

FIG. 4B is an illustrative schematic perspective view showing the bracket of the fastening device right-side up in an installed orientation;

FIG. 5 is an illustrative schematic view of an embodiment of the fastening device having an arch-shaped recess 5 and an arch-shaped hooked portion 7 during a sudden slowing or stopping of the vehicle and showing the hooked member 6 tilted to the right which in the illustration, is toward the front of the slowing vehicle;

FIG. 6 is an illustrative schematic view of an embodiment of the fastening device having a squared-off recess 5 and a flat hooked portion 7; and

FIG. 7 is an illustrative schematic perspective view of an exemplary installation of four load carrier feet with two load bars connected therebetween in an installed configuration on a carrying vehicle 30 in accordance with the present disclosure.

### SUMMARY

Implementations according to the present disclosure include a fastening device for a load carrier of a vehicle, which securely holds the load carrier during normal use, but which allows deformation of the load carrier in an accident. Embodiments of the present disclosure overcome the above mentioned disadvantages of known load carriers by including a bracket with an elongated recess or hole having either substantially longitudinally elongate or arched longitudinal edges and corresponding ledge surfaces, whereby a hooked portion of a hooked member, for example a head of a bolt, may longitudinally slide along the longitudinally elongate or arched edges, and corresponding ledge surfaces, and tilt forward during a sudden slowing or stopping of the carrying vehicle. The sliding motion is facilitated by an engagement surface of the hooked portion that is width-wise more narrow than the ledge surface is long.

### DESCRIPTION OF EXAMPLE EMBODIMENTS

Exemplary implementations according to the present disclosure will be described more fully hereinafter with reference to the accompanying drawings. Other embodiments are contemplated in many different forms, and this disclosure should not be construed as limited to the embodiments set forth herein; rather, these embodiments are provided so that this disclosure will be thorough and complete, and will fully convey the scope of the disclosure to those skilled in the art. In the drawings, like numbers refer to corresponding or like elements.

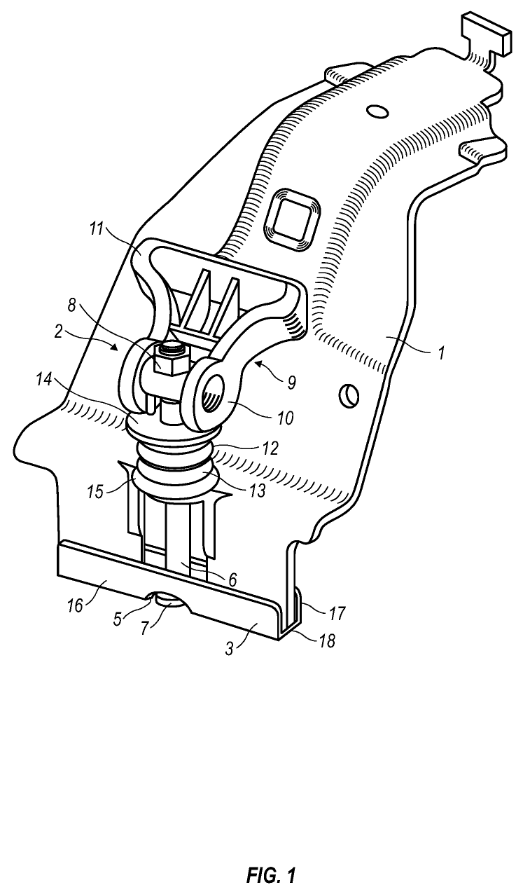

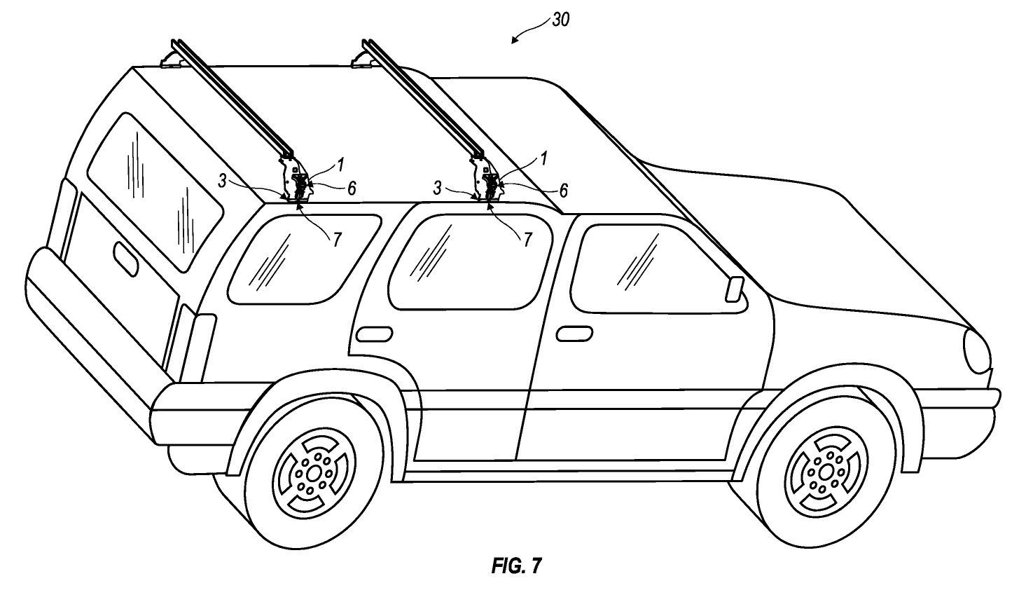

FIG. 1 illustrates a load carrier foot 1 having a fastening device 2 for a load carrier comprising a bracket 3 arranged at the roof of a vehicle (see FIG. 7) with at least one fastening means (not shown) firmly fastened at the roof through means such as screwing, riveting, or welding. The fastening means comprises, for example, at least one bolt which extends through a threaded hole (not shown) in the roof of the vehicle. The bracket 3 may be made of steel and is preferably made of high-strength steel. Bracket 3 is illustrated in FIG. 1 as a U-shaped girder having side walls 16 and 17, and at least one elongated rectangular recess 5 for detachable clamping of the load carrier foot 1. Alternatively, the girder may be L-shaped. The recess can take the form of an aperture, as illustrated in FIG. 1, or an indentation.

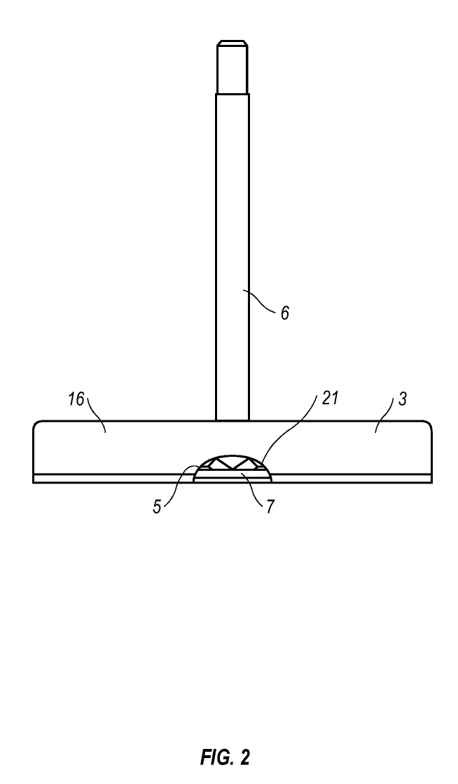

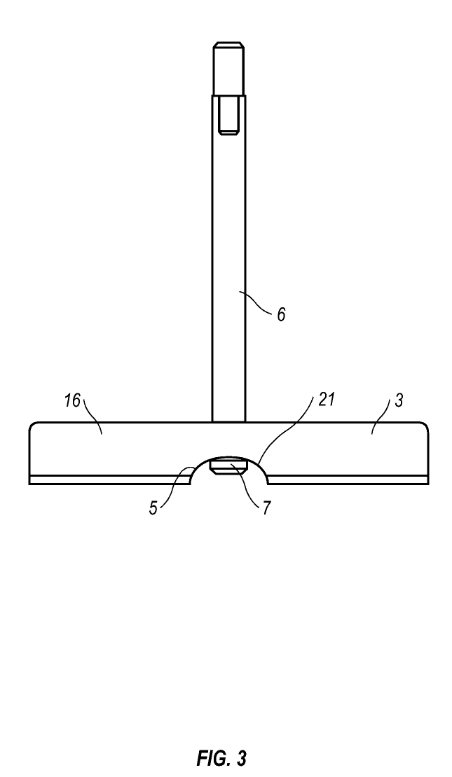

The fastening device 2 comprises an axially movable hooked member 6 with a hooked portion 7 arranged at a lower end thereof. The hooked portion 7 can be configured to be substantially T-shaped (inverted) or L-shaped and sized so that the hooked portion 7 is insertable into or through the recess 5 when a long dimension of the hooked portion 7 is substantially aligned with a long dimension of the recess 5. Thereafter, a twisting action of the hooked member 6 achieves an axial locking and/or a conformance fit of the hooked portion 7 with bracket 3 by engagement of an upper surface of hooked portion 7 on a lower surface of a ledge or edge of the recess 5. The twisting action is illustrated between FIGS. 2 and 3, wherein FIG. 2 illustrates the hooked portion 7 of hooked member 6, with a T-shape, inserted through recess 5 in the bracket 3.

FIG. 3 illustrates the hooked portion 7 of hooked member 6 after being twisted in recess 5 to abut a ledge surface 21. A nut 8 may be arranged at an upper end of hooked member 6 for retracting and extending the lower hooked end 7 into and out of secured engagement with the bracket 3.

As illustrated, the fastening device 2 comprises a quick coupling 9 in a shape of an eccentric 10, with a handle 11, whereby eccentric 10 may be engaged to achieve a suitable clamping force. In one embodiment, quick coupling 9 comprises a spacer 12 and a spring 13 arranged between an upper washer 14 and a lower washer 15 which is provided on a top end of hooked member 6 between eccentric 10 and load carrier foot 1. When a user assembles the vehicle load carrier, a lower end of each load carrier foot 1 is placed within a bracket 3 between side walls 16 and 17 thereof for securement thereto.

FIGS. 2 and 3 illustrate the hooked member 6 with its hooked portion 7 and a bracket 3 with its receiving recess 5 bounded by the edge 21. FIG. 2 illustrates a first assembly position in which hooked member 6 has been moved through recess 5. FIG. 3 illustrates a second assembly position in which hooked member 6 has been twisted, and hooked member 6 is tightened in such way that hooked portion 7 abuts against at least one of side walls 16 and 17 at a ledge surface 21 and/or 22 of bracket 6 and because of the ledge(s)' arch shape, is urged to a high-center position.

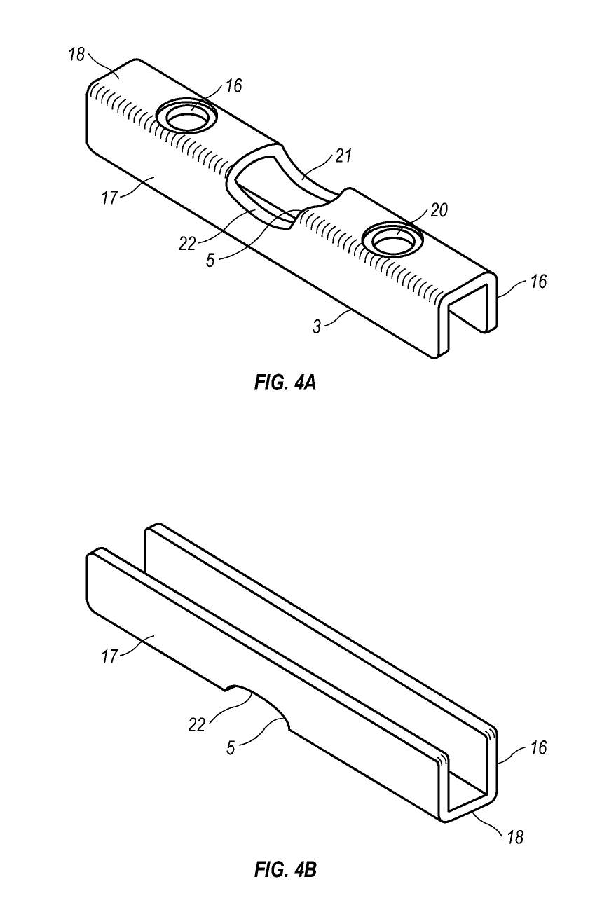

FIGS. 4A and 4B illustrate bracket 3 as a plate bent to form a U-shaped girder with recess 5 arranged in a base 18 of bracket 3. Preferably, recess 5 is shaped by punching the plate, which is made of, for example, steel. Naturally, the recess can also be shaped by mechanically working the material by drilling, milling, grinding, and etcetera. FIG. 4A depicts the bracket in an upside down orientation detailing a lower portion of the bracket while in FIG. 4B the bracket 3 is shown in an installed configuration as when installed onto a carrying vehicle.

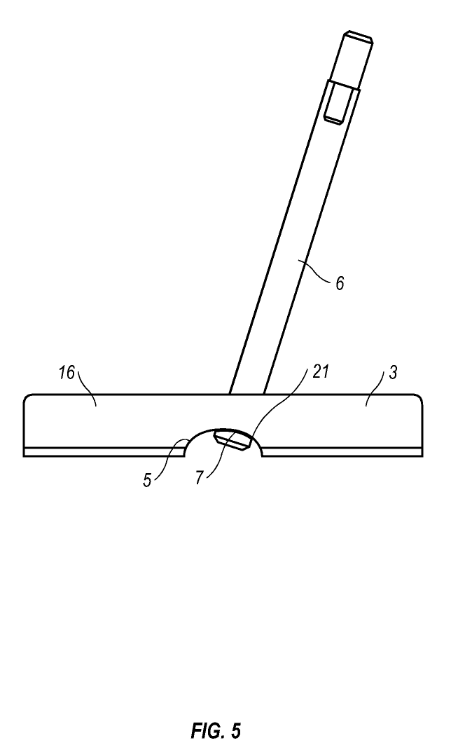

In one embodiment of the disclosure, recess 5 comprises, for example, arched longitudinal edges 21 and 22 that form corresponding ledge surfaces, whereby hooked portion 7 of hooked member 6 may longitudinally slide along the arched edges 21 and 22, and corresponding ledge surfaces, and tilt forward during a sudden slowing or stopping of the vehicle (see FIG. 5). An upper engagement surface of hooked portion 7 is width-wise more narrow than the length of the longitudinal ledge surfaces, thereby facilitating the sliding motion that will normally occur during rapid deceleration, such as in a crash situation. Moreover, arched longitudinal ledge surfaces 21 and 22 help create a better distribution of force between bracket 3, the connection to the roof, and hooked portion 7 of hooked member 6 during a vehicular crash. Force distribution and the proclivity of hooked member 6 to longitudinally slide may be further enhanced by forming hooked portion 7 of hooked member 6 to have an arched abutting surface conforming to fit with ledges 21 and 22, thereby securing hooked member 6 with a face-to-face conformance fit. Because of the arch shape of the recess 5, the hooked portion 7 is further urged to a high-center position on the ledges 21 and 22 when the fastening device is tightened. During a crash, load carrier foot 1 may be deformed after sliding forward along arched longitudinal ledge surfaces 21 and 22 of bracket 3.

In some embodiments of the disclosure, an area of recess 5 may be completely removed thereby forming an aperture. In other embodiments, the body of bracket 3 may remain substantially continuous, but with recesses formed into one or both of side walls 16 and 17 of the bracket 3.

Side walls 16 and 17 of bracket 3 may be oblique in relation to base 18 to be adapted to the roof of a vehicle. FIG. 4A further illustrates two holes 19 and 20 for releasably securing the bracket 3 to the roof of the vehicle using bolts (not shown). Additionally, seals (not shown) having a shape similar to O-rings may be used to seal the roof. In another aspect, a lower edge of load carrier foot 1 may have recesses (not shown) for the hooked members.

As described above, in the event of a collision, hooked member 6 may tilt in the direction of the collision due to inertial force and rapid deceleration. FIG. 5 illustrates a schematic view of hooked member 6 during such a collision. As can be seen in FIG. 5, hooked member 6 is tilted to the right due to inertial force in a rightward direction. Moreover, the inertial force causes hooked portion 7 of hooked member 6 to longitudinally slide along ledge surface 21. The sliding motion is facilitated by an upper engagement surface of hooked portion 7 that is width-wise more narrow than the ledge surface 21 is long, i.e., there is room for hooked member 6 to slide back and forth on the ledge surface(s).

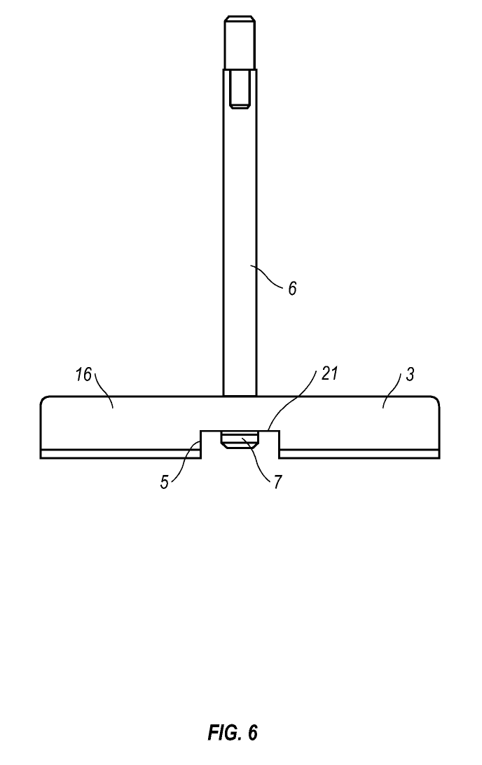

FIG. 6 illustrates a second embodiment in which ledge surface 21 is substantially flat and is lengthwise longer than the hooked portion 7 of hooked member 6 is widthwise wide. The larger size of ledge surface 21 enables hooked member 6 to longitudinally slide back and forth in response to inertial forces during acceleration and deceleration of the carrying vehicle.

FIG. 7 illustrates one use of a fastening device in accordance with the present disclosure shown in an installed configuration. Two fastening devices 1 in accordance with the present disclosure can be seen on each of two lateral sides of the carrying vehicle. Each fastening device comprises a hooked member 6 having a hooked portion 7, and a bracket 3. Bracket 3 is installed in an orientation similar to that shown in all the other figures except for FIG. 4A, which shows the bracket in an upside down orientation.

While described generally herein, it is anticipated that the hooked portion of the hooked member can be of a squared, L-type shape or an otherwise angled hooked configuration. The shape of the brackets may also be altered within the frame of the present patent claims, for example the bracket may be substantially U-shaped or L-shaped.

In the drawings and specification, there have been disclosed preferred embodiments and examples, although specific terms are employed, they are used in a generic and descriptive sense only and not for the purpose of limitation, the scope of the disclosure being set forth in the following claims.

We claim:

1. A bracket configured to be fastened to a carrying vehicle in an installed configuration and adapted to releasably receive a hooked member of a load carrier foot, said bracket comprising:
an elongate bracket body comprising a base wall interconnected with at least one side wall in a generally L-shaped cross-sectional orientation, wherein said at least one side wall is generally upstanding in the installed configuration;
a recess into said side wall, said recess having a ledge surface in the installed configuration that abuttingly receives a hooked member of a load carrier foot when secured thereupon from an interior side of the L-shaped cross-section; and
said ledge surface facing generally downward in the installed configuration.

2. The bracket as recited in claim 1, wherein said ledge surface is longitudinally elongate thereby facilitating longitudinal sliding of a secured hooked member thereupon.

3. The bracket as recited in claim 1, wherein said ledge surface is upwardly arch-shaped in the installed configuration whereby a secured hooked member is urged to a high-center position on said arch-shaped ledge surface.

4. The bracket as recited in claim 1, further comprising:
an aperture through said base wall and said at least one side wall, an edge of said aperture forming said arch-shaped ledge surface of said recess.

5. The bracket as recited in claim 1, further comprising:
a second side wall interconnected with said base wall; and
said at least one side wall, said base wall and said second side wall being interconnected in a generally U-shaped cross-sectional orientation that is generally upwardly open in the installed configuration.

6. The bracket as recited in claim 5, further comprising:
an aperture through said at least one side wall, said base wall and said second side wall, an edge of said aperture forming an arch-shaped ledge surface in each of said at least one side wall and said second side wall in the installed configuration.

7. The bracket as recited in claim 1, wherein said elongate bracket body further comprises at least one fastener receiving aperture in said base wall.

8. The bracket as recited in claim 1, wherein said elongate bracket body further comprises a pair of fastener receiving apertures in said base wall, each aperture symmetrically oriented, one to the other, on opposite sides of said recess.

9. A load carrier foot configured to be mounted upon a carrying vehicle in an installed configuration and adapted to releasably hook into a recess of a receiving bracket fastened to the carrying vehicle, said load carrier foot comprising:
an upper portion connectable to a load carrier bar in the installed configuration;
a retractable hooked member interconnected with said upper portion, said hooked member having, in cross-section, a generally L-shaped lower hook-end;
said hook-end of said hooked member comprising a hook portion insertable into a longitudinally elongate recess in a receiving bracket fastened to a carrying vehicle in the installed configuration; and
said hook portion having an upper engagement surface that is width-wise more narrow than a length of the longitudinally elongate recess thereby facilitating longitudinal sliding of a secured hooked member thereupon.

10. The load carrier foot as recited in claim 9, wherein said upper engagement surface of said hook portion is upwardly arch-shaped whereby said hook portion conformance fits in abutting engagement with an arch-shaped ledge surface of a receiving recess.

11. The load carrier foot as recited in claim 9, wherein said hooked member has a double-hooked hook portion that in cross-section has an inverted T-shaped lower hook-end.

12. The load carrier foot as recited in claim 9, further comprising:
a nut and bolt combination interconnecting said retractable hooked member to said upper portion and which is operable to affect extension and retraction of said hooked member relative to said upper portion.

13. A load carrier device configured to be fastened to a carrying vehicle in an installed configuration, said device comprising:
an elongate bracket body comprising a base wall interconnected with at least one side wall in a generally L-shaped cross-sectional orientation, wherein said at least one side wall is generally upstanding in the installed configuration;
a load carrier foot comprising a retractable hooked member having, in cross-section, a generally L-shaped lower hook-end; and
a recess into said side wall of said elongate bracket body, said recess having a ledge surface facing generally downward in the installed configuration and abuttingly engaged with a hook portion of said hooked member;
said ledge surface is longitudinally elongate and the hooked member is secured thereupon, said hooked member comprising a hook portion having an upper engagement surface that is width-wise more narrow than a length of the longitudinally elongate recess thereby facilitating longitudinal sliding of said secured hooked member on said ledge surface in the installed configuration.

14. The load carrier device as recited in claim 13, wherein said ledge surface and said hook portion are each upwardly arch-shaped and conformance fitting, one to the other in the installed configuration.

15. The load carrier device as recited in claim 13, further comprising:
a nut and bolt combination connected to said retractable hooked member and which is operable to affect extension and retraction of said hooked member.

16. The load carrier device as recited in claim 13, further comprising:
an aperture through said base wall and said at least one side wall, an edge of said aperture forming said arch-shaped ledge surface of said recess.

17. The load carrier device as recited in claim 13, further comprising:
a second side wall interconnected with said base wall; and
said at least one side wall, said base wall and said second side wall being interconnected in a generally U-shaped cross-sectional orientation that is generally upwardly open in the installed configuration.

18. The load carrier device as recited in claim 17, wherein said hooked member has a double-hooked hook portion that in cross-section has an inverted T-shaped lower hook-end.

19. The load carrier device as recited in claim 17, further comprising:
an aperture through said at least one side wall, said base wall and said second side wall, an edge of said aperture forming an arch-shaped ledge surface in each of said at least one side wall and said second side wall.

20. The load carrier device as recited in claim 13, wherein said elongate bracket body further comprises at least one fastener receiving aperture in said base wall.

21. The load carrier device as recited in claim 13, wherein said elongate bracket body further comprises a pair of fastener receiving apertures in said base wall, each aperture symmetrically oriented, one to the other, on opposite sides of said recess.
